(19) United States
(12) Patent Application Publication
(10) Pub. No.: US 2026/0029662 A1
(43) Pub. Date: Jan. 29, 2026

(54) Shortened Temples with Elastomeric Foam Sleeves for Eyeglass Frame

(71) Applicant: Lisa A. Foster, Windsor, NY (US)

(72) Inventor: Lisa A. Foster, Windsor, NY (US)

(21) Appl. No.: 18/785,618

(22) Filed: Jul. 26, 2024

(51) Int. Cl. G02C 5/14; G02C 5/16

(52) U.S. Cl. CPC G02C 5/143; G02C 5/16

(57) ABSTRACT

A pain-free eyeglass frame comprising a pair of shortened bayonet temples, each of the pair of shortened bayonet temples having an elastomeric foam covering along a portion of its length, the elastomeric foam covering having a thickness sufficient to rest securely within the shallow depression of a human ear between the eminence of triangular fossa and the skull. More particularly, elastomeric foam covering may be in the form of an elastomeric foam sleeve or an elastomeric foam cover. In use, the elastomeric foam covering contacts the shallow depression of the wearer's ear, thereby preventing chafing, irritation, or digging into the top of the user's ear and skull are adjacent the ear, and resulting in a pain-free eyeglass frame.

### FIELD OF THE INVENTION

The present invention relates to shortened bayonet temples for use with an eyeglass frame, each shortened temple having an elastomeric foam covering along a segment of its length including to the end of the temple distal from the eyeglass frame. Each of the shortened temples is designed in such a manner that a portion of the elastomeric foam covering rests in the shallow depression between the eminence of triangular fossa and the skull.

### BACKGROUND OF THE INVENTION

Traditionally, eyeglass frames have been designed with different temple lengths from which to choose, such as 135 and 140, which determine the length of the temples or arms. These traditional frames run lengthwise from the lens sitting on the top of the ears and then bending or curving downwardly at the end such that it sits behind the ear and along the skull. This design is the most common design in use today because when the wearer of the eyeglass frame leans forward, the eyeglass frame does not slip off user and onto the floor or ground.

Another style of eyeglass frame utilizes bayonet temples which have a straight design and extend beyond the top the ear, creating a slight pressure against the skull. The bayonet temples conventionally have been used on sunglass frames and are useful when one is wearing a helmet or a headset as the glasses can be removed without removing the headset or helmet. However, as the bare temple rests on top of the ear, rather than behind the ear, the bare temple can chafe and irritate that part of the ear.

### PRIOR ART

The prior art is replete with eyeglass frames having varied styles of temples, including a covering for part of the temple arm. In U.S. Patent Application Publication 2001/0043308A1 to Menuck et al., filed May 9, 2002 and published on Nov. 22, 2002, temples are shown which extend downwardly behind the ear and are provided with a loosely fitting cover to protect that temple arms from being contaminated with hair dye. U.S. Pat. No. 5,384,605 to Escobosa, issued Jan. 24, 1995 relates to a dual-function eyeglass retainer/sweatband providing for tight and loose configurations. The Escobosa eyeglass includes retainer portions composed of an elastomeric foam such as neoprene which are attached to a central portion of the sweatband to form a unitary linear strap. Despite the creativity of the prior art, a need still exists for an eyeglass frame having temples which are comfortable and pain free and which remain in place even when the user bends forward.

### SUMMARY OF THE INVENTION

The present subject matter relates to a pair of shortened bayonet temples having an elastomeric foam covering or sleeve along a segment length of each temple for use with an eyeglass frame. The shortened temples rest comfortably and pain-free within the shallow depression between the eminence of triangular fossa and the skull. The elastomeric foam sleeve is of sufficient diameter or thickness that an eyeglass frame utilizing a pair of such shortened temples remains in place even when the eyeglass wearer bends forward.

Accordingly, it is an object of the present subject matter to provide a pair of shortened bayonet temples having an elastomeric foam sleeve along a length of a segment of each temple for use with an eyeglass frame such that the bare temple piece does not contact the ear or skull.

It is another object of the present subject matter to provide a pair of shortened bayonet temples having an elastomeric foam sleeve along a length of a segment of each temple for use with an eyeglass frame that do not dig into, chafe, exert excessive pressure, or otherwise irritate the user's ear or skull.

It is yet another object of the present subject matter to provide a pair of shortened bayonet temples having an elastomeric foam sleeve along a length of a segment of each temple for use with an eyeglass frame, wherein the elastomeric foam sleeve rests comfortably in the shallow depression between the eminence of triangular fossa and the skull.

It is an additional object of the present subject matter to provide a pair of shortened bayonet temples having an elastomeric foam sleeve along a length of a segment of each temple for use with an eyeglass frame that is comfortable to wear.

It is a further object of the present subject matter to provide a pair of shortened bayonet temples having an elastomeric foam sleeve along a length of a segment of each temple for use with an eyeglass frame that is pain-free when worn.

It is still a further object of the present subject matter to provide a pair of shortened bayonet temples having an elastomeric foam coating along a length of a segment of each temple of sufficient thickness that each temple rests comfortably within the shallow depression between the eminence of triangular fossa and the skull.

It is an additional object of the present subject matter to provide a pair of shortened bayonet temples having an elastomeric foam coating at the end segment of each temple for use with an eyeglass frame, wherein the elastomeric foam is neoprene.

### BRIEF DESCRIPTION OF DRAWINGS

FIG. 1 is a top environmental view of the shortened bayonet temples of the present subject matter resting in the shallow depression between the eminence of triangular fossa and the skull of a wearer.

FIG. 2 is a side perspective view of the shortened bayonet temples of the present subject matter each having an elastomeric foam sleeve along a segment of its length.

### DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. least one specification heading is required.

In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The present subject matter is directed to a pair of shortened bayonet temples for use with an eyeglass frame. Each of the pair of shortened bayonet temples is provided with an elastomeric foam covering along a segment of its length including to the end of the temple distal from the eyeglass frame. This segment upon which the elastomeric foam covering is disposed hereinafter sometimes may be referred to as the segment end or segment end of the temple.

In a preferred embodiment of the present subject matter, the elastomeric foam covering may in the form of an elastomeric foam sleeve. More preferably, the elastomeric foam may be composed of neoprene or a neoprene-containing composite. In another embodiment, the elastomeric foam covering may be in the form of a coating which is applied to the segment end of the temple during the manufacturing process. The coating may be composed of neoprene. In addition to neoprene, it is to be understood and will be obvious to those skilled in the art that any elastomeric foam material may be suitable for use as the coating or sleeve.

Bayonet temples generally do not curve or bend downwardly behind the ear and as such do not cause irritation, indentation, or pain behind the ear. However, as the bayonet temple rests on top of the ear and against the skull, a bare temple can dig into the top or upper ear portion of the wearer as well as on the side of the skull above the ear. This digging into or chafing along this area of the ear can create great discomfort, physical pain, and damage, such as acanthoma fissuratum, to the wearer of the eyeglass frame with bare bayonet temples, as well as leave indentations on the ear. In contrast, with the pair of shortened bayonet temples of the present subject matter having an elastomeric covering at least the segment end of each temple, there are no bare arms that dig into the upper ear and leave indentations in the sides of the user's head. Further, because these shortened bayonet temples are designed to rest in the shallow depression between the eminence of triangular fossa and the skull, there is no discomfort. The result is pair of pain-free eyeglasses. Moreover, the thickness or diameter of the elastomeric foam covering is of sufficient size that it not only rests comfortably within the shallow depression but remains in place even when the wearer bends forward. In other words, the eyeglasses do not slide off the wearer when the wearer leans or bends forward.

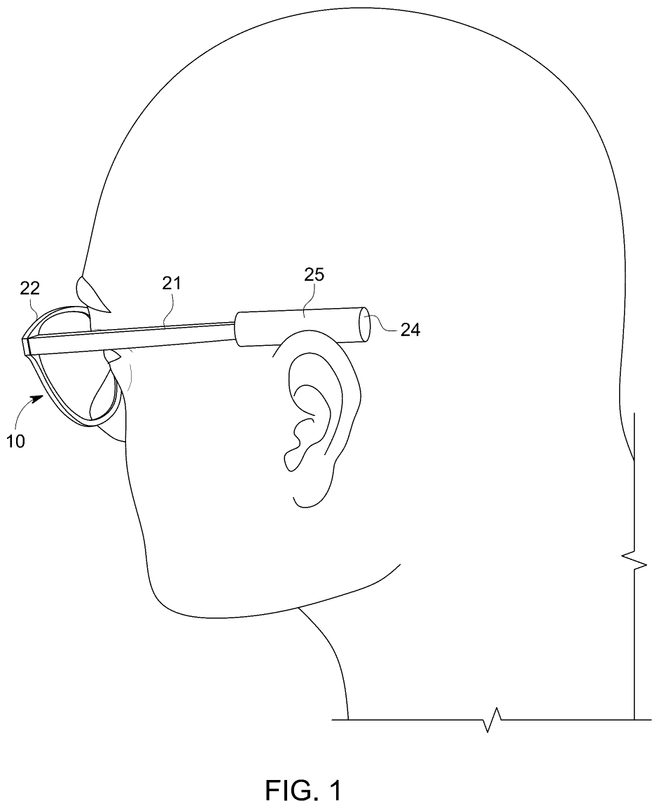

Referring to FIG. 1, a shortened left bayonet temple 21 is shown having an elastomeric foam sleeve 25, a portion of the foam sleeve being disposed and resting within the shallow depression between the eminence of triangular fossa and the skull.

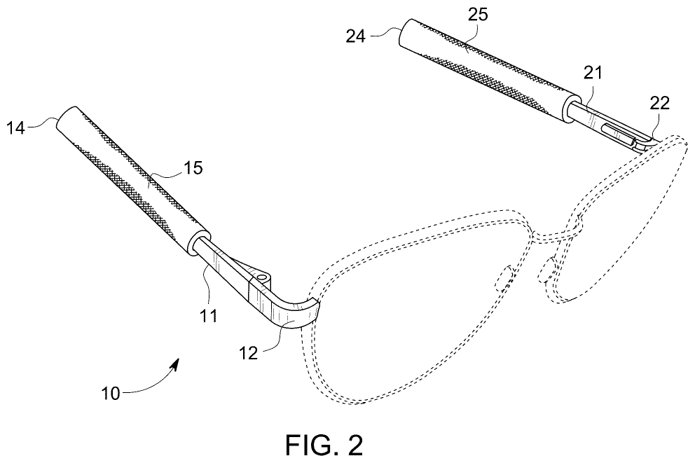

Referring now to FIG. 2, an eyeglass frame 10 is shown having a pair of shortened bayonet temples, each having a predetermined length and being provided with an elastomeric foam sleeve along a segment of its length. More particularly, the pair of shortened bayonet temples includes a shortened right temple 11 and a shortened left temple 21. Shortened right temple 11 comprises a proximal end 12 which is adapted to attach to an eyeglass frame and a distal end 14, the length of the temple being the distance between its proximal end and distal end. The shortened right temple 11 further comprises an elastomeric foam sleeve 15 along at least a portion of its length including its distal end 14.

The shortened left temple 21 comprises a proximal end 22 which is adapted to attach to an eyeglass frame and a distal end 24, the length of the shortened left temple being the distance between its proximal end and its distal end. The shortened left temple 21 further comprises an elastomeric foam sleeve 25 along at least a portion of its length including its distal end.

It is to be understood that while the pair of shortened temples 11 and 21 are shown in FIG. 2 having elastomeric foam sleeves 15 and 25 respectively, any type of elastomeric foam covering may be used including an elastomeric foam coating during the manufacturing process. As discussed hereinabove, in one embodiment, the elastomeric foam covering is a neoprene sleeve. In another embodiment, the elastomeric foam covering is a neoprene coating.

When a pair of eyeglasses are hurting a wearer's ears, it usually is due to the temples applying excessive pressure on the ears. By utilizing a pair of shortened bayonet temples having the elastomeric foam covering along the portion of the length of the temple that rests in the shallow depression between the eminence of triangular fossa and the skull, this excessive pressure is eliminated. As a result, the wearer of the eyeglass frame with the pair of shortened bayonet temples of the present subject matter experiences comfort and without the pain causing pressure exerting by a bare temple resting in this shallow depression.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A pair of shortened bayonet temples for use with an eyeglass frame, each of said pair of shortened bayonet temples having a proximal end adapted to attach to an eyeglass frame, a distal end, and a length between said proximal end and said distal end, said elastomeric foam covering being disposed along at least a portion of said length including said distal end, said elastomeric foam covering being of sufficient thickness to rest in the shallow depression of a human ear between the eminence of triangular fossa and the skull in such a manner that it does not exert excessive pressure on the user's ears.

2. The pair of shortened bayonet temples in accordance with claim 1, wherein said elastomeric foam covering is in the form of an elastomeric foam sleeve.

3. The pair of shortened bayonet temples in accordance with claim 2, wherein said elastomeric foam sleeve is a neoprene-containing sleeve.

4. The pair of shortened bayonet temples in accordance with claim 1, wherein said elastomeric foam covering is in the form of an elastomeric foam coating.

5. The pair of shortened bayonet temples in accordance with claim 1, wherein said elastomeric foam coating is a neoprene-containing coating.

6. The pair of shortened bayonet temples in accordance with claim 1, wherein said elastomeric foam covering is said sufficient thickness that said pair of shortened bayonet temples remain within the shallow depression when a user bends forward.
